(19) United States
(12) Patent Application Publication
(10) Pub. No.: US 2007/0129117 A1
(43) Pub. Date: Jun. 7, 2007

(54) MOBILE TELECOMMUNICATION DEVICE WITH FRONT EMBEDDED BATTERY

(76) Inventors: Ying-Xing Lee, Taipei City (TW); Hsi-Yung Liu, Taipei City (TW); Wen-Yi Kuo, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,985

(22) Filed: Jun. 2, 2006

(30) Foreign Application Priority Data
Dec. 7, 2005 (TW) 94143095

(51) Int. Cl. H04M 1/00; H04B 1/38

(52) U.S. Cl. 455/572

(57) ABSTRACT

A mobile telecommunication device with a front embedded battery includes a casing, a keypad, a first fixing unit, a second fixing unit and a battery. The casing has a front surface and a cavity, while an open end of the cavity is exposed over the front surface. The keypad is moveably disposed on the front surface for opening or closing the open end of the cavity. The first fixing unit is disposed between the casing and the keypad for fixing the keypad position relative to the casing. The second fixing unit is disposed between the casing and the keypad for fixing the keypad position relative to the casing. The battery is stored inside the cavity.

### CROSS-REFERENCE TO RELATED APPLICATION

This application claims the priority benefit of Taiwan application serial no. 94143095, filed on Dec. 7, 2005. All disclosure of the Taiwan application is incorporated herein by reference.

### BACKGROUND OF THE INVENTION

1. Field of Invention

The present invention relates to a mobile telecommunication device, and particularly to a mobile telecommunication device with a front embedded battery.

2. Description of the Related Art

In the modern information society where electronic technology is increasingly indispensable for people, electronic products, such as a computer or a mobile phone, pervade everywhere in our daily life. Today, people usually use phones to communicate between locations. Along with the continuous price fall of mobile phone sets and communication service charges, mobile phones become one of the most convenient and fastest communication means today.

Due to the enormous needs on the mobile data transmission, the communication service governed by the conventional GSM (the global system for mobile communications) standard can not meet the demand. Instead, the new communication service governed by 3G (the third generation system for mobile communications) standard is currently prevalent. Thanks to the rate of wireless data transmission with the 3G mobile communications much higher than the rate with the conventional GSM, the modern 3G communication service provides not only a regular voice transmission, but also an instant image transmission function. Therefore, in terms of the communication efficiency, a mobile phone adopting the 3G standard must have the upper hand over a conventional one.

The advanced efficiency of a 3G mobile phone also brings a more complicated circuit and structure with a 3G mobile phone. Accordingly, it is an obstacle to minimize a 3G mobile phone because of the complicated circuit and structure. Therefore, how to maintain the high communication efficiency of the 3G standard and meet the minimization requirement of a 3G portable mobile phone is an important issue the manufacturers in this field must face.

### SUMMARY OF THE INVENTION

An object of the present invention is to provide a mobile telecommunication device with a front embedded battery, suitable for a minimizing design thereof.

Another object of the present invention is to provide a mobile telecommunication device with a front embedded battery, suitable for advancing the convenience of battery replacement.

Based on the above or other objects, the present invention provides a mobile telecommunication device with a front embedded battery, which includes a casing, a keypad, a first fixing unit, a second fixing unit and a battery. The casing has a front surface and a cavity, wherein an open end of the cavity is exposed over the front surface and the keypad is movably attached to the front surface for opening or closing the open end of the cavity. The first fixing unit is disposed between the casing and the keypad for fixing the position of the keypad relative to the casing. The second fixing unit is disposed between the casing and the keypad for fixing the position of the keypad relative to the casing. The battery is stored in the cavity.

In an embodiment of the present invention, the mobile telecommunication device further includes an image display panel, which is disposed on the front surface facing over the front surface.

In an embodiment of the present invention, the keypad is slid on the front surface of the casing, so that the keypad is able to slide relatively to the casing for opening or closing the open end of the cavity.

In an embodiment of the present invention, the mobile telecommunication device further includes a sliding mechanism disposed between the casing and the keypad, and the keypad uses the sliding mechanism to slide relatively to the casing.

In an embodiment of the present invention, the keypad is pivoted on the front surface of the casing, so that the keypad is able to swing relatively to the casing for opening or closing the open end of the cavity.

In an embodiment of the present invention, the mobile telecommunication device further includes a hinge mechanism disposed between the casing and the keypad, and the keypad uses the hinge mechanism to swing relatively to the casing.

In an embodiment of the present invention, the first fixing unit includes at least a latch male and at least a corresponding latch female, which are disposed on the casing and the keypad, respectively.

In an embodiment of the present invention, the first fixing unit is a hinge mechanism disposed between the casing and the keypad, and the keypad uses the hinge mechanism to swing relatively to the casing.

In an embodiment of the present invention, the second fixing unit includes at least a latch male and at least a latch female, which are disposed on the casing and the keypad, respectively.

In an embodiment of the present invention, the mobile telecommunication device further includes a printed circuit board (PCB) disposed in the casing, and the cavity further has another open end, which faces inside of the casing and is closed by the PCB.

In an embodiment of the present invention, the battery contacts the PCB.

In an embodiment of the present invention, the casing includes a first sub-casing and a second sub-casing, wherein the first sub-casing is moveably connected with the second sub-casing; the second sub-casing has a cavity; and the keypad is moveably disposed on the front surface of the second sub-casing for opening or closing the open end of the cavity.

In an embodiment of the present invention, the first sub-casing is pivoted or slid on the second sub-casing.

Based on the above described, in the present invention, a cavity is disposed under the keypad of the mobile telecommunication device and the keypad is able to move relatively to the casing for closing or opening an open end of the cavity so as to install, take out or replace the battery.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is an exploded drawing of a mobile telecommunication device with a front embedded battery according to the first embodiment of the present invention.

FIG. 2A is a perspective view schematically showing the localized battery and the localized cavity after removing the keypad of the mobile telecommunication device in FIG. 1.

FIG. 2B is a cross-sectional view along line I-I in FIG. 2A.

FIG. 3A is a perspective view schematically showing the assembled parts of the mobile telecommunication device in FIG. 1.

FIG. 3B is a cross-sectional view along line II-II in FIG. 3A.

FIG. 4A is a perspective view of a mobile telecommunication device with a front embedded battery according to the second embodiment of the present invention.

FIG. 4B is a cross-sectional view along line III-III in FIG. 4A.

FIG. 5 is a perspective view of a mobile telecommunication device with a front embedded battery according to the third embodiment of the present invention.

FIG. 6 is a perspective view of a mobile telecommunication device with a front embedded battery according to the fourth embodiment of the present invention.

### DESCRIPTION OF THE EMBODIMENTS

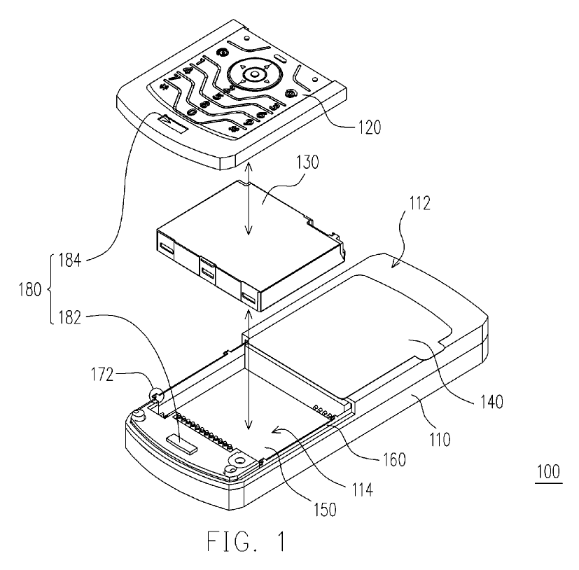

FIG. 1 is an exploded drawing of a mobile telecommunication device with a front embedded battery according to the first embodiment of the present invention. Referring to FIG. 1, a mobile telecommunication device with a front embedded battery 100 of the first embodiment includes a casing 110, a keypad 120 and a battery 130. The casing 110 has a front surface 112 and a cavity 114, and an open end of the cavity 114 is exposed over the front surface 112. The keypad 120 is moveably disposed on the front surface 112 for opening or closing the open end of the cavity 114. The battery 130 is suitable for being stored in the cavity 114.

The mobile telecommunication device 100 further includes an image display panel 140, disposed on the front surface 112 of the casing 110 and facing over the front surface 112 to display images for users. The mobile telecommunication device 100 further includes a printed circuit board (PCB) 150 disposed in the casing 110, and the cavity 114 further has another open end opposite to the above-described open end facing inside the casing 110 and closed by the PCB 150. The battery 130 can directly contact the PCB 150. All such designs are intended for thinning the overall thickness of the mobile telecommunication device 100.

The mobile telecommunication device 100 further includes a sliding mechanism 160 disposed between the casing 110 and the keypad 120, and the keypad 120 can be slidably disposed on the front surface 112 of the casing 110 by means of the sliding mechanism 160. The sliding mechanism 160 includes a slide track and a slide block (not shown in the figure), which are disposed on the casing 110 and the keypad 120 respectively for providing the keypad 120 with sliding movements relative to the casing 110.

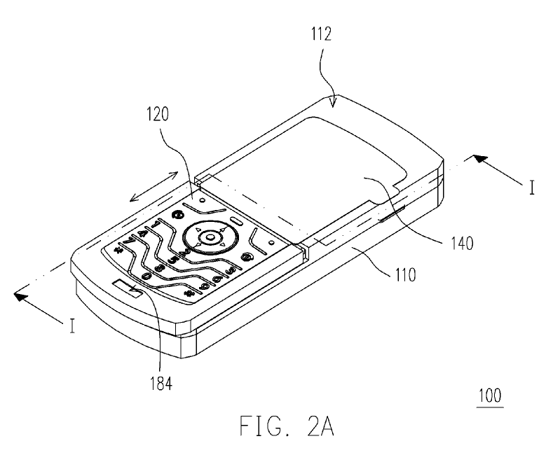

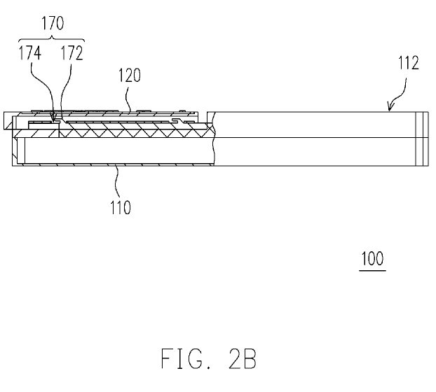

The mobile telecommunication device 100 further includes a first fixing unit 170 (shown in FIG. 2B) disposed between the casing 110 and the keypad 120 for fixing the position of the keypad 120 relative to the casing 110. The first fixing unit 170 includes a plurality of latch males 172 and a plurality of corresponding latch females 174 (shown in FIG. 2B), which are disposed on the sliding mechanism 160 and the keypad 120 respectively for restricting the vertical position of the keypad 120 relative to the casing 110.

The mobile telecommunication device 100 further includes a second fixing unit 180 disposed between the casing 110 and the keypad 120 for fixing the position of the keypad 120 relative to the casing 110. The second fixing unit 180 includes a latch male 182 and a latch female 184, which are disposed on the casing 110 and the keypad 120 respectively for restricting the horizontal position of the keypad 120 relative to the casing 110. Besides, the latch male 182 can be disposed with resiliency on the casing 110, so that the latch male can move downward with an exerted force and be sprung back once the exerted force is released. An engagement between the latch male 182 and the latch female 184 can be released by pressing down the latch male 182.

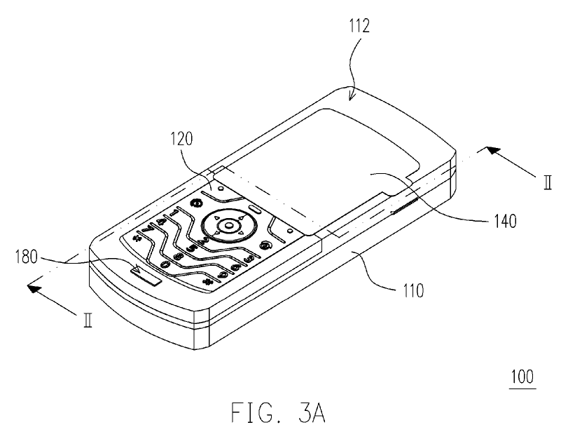

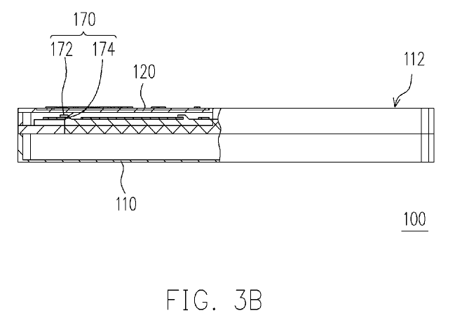

FIG. 2A is a perspective view schematically showing the localized battery and the localized cavity after removing the keypad of the mobile telecommunication device in FIG. 1, while FIG. 2B is a cross-sectional view along line I-I in FIG. 2A. FIG. 3A is a perspective view schematically showing the assembled parts of the mobile telecommunication device in FIG. 1, while FIG. 3B is a cross-sectional view along line II-II in FIG. 3A. Referring to FIGS. 1, 2A, 2B, 3A and 3B, to install a battery 130 into the casing 110, the battery 130 is placed in the cavity 114, followed by sliding back the keypad 120 to a predetermined position relative to the casing 110. In this way, the open end of the cavity 114 is closed and the battery 130 is stored inside the casing 110, as shown sequentially in FIG. 1, FIG. 2A and FIG. 3A.

When the keypad 120 slides back to the predetermined position relative to the casing 110 by an exerted force, the latch males 172 of the first fixing unit 170 are engaged with the corresponding latch females 174 for restricting the vertical position of the keypad 120 relative to the casing 110, as shown in FIG. 3B, and the latch male 182 of the second fixing unit 180 further engages the corresponding latch female 184 for restricting the horizontal position of the keypad 120 relative to the casing 110, as shown in FIG. 3A.

Inversely, when a user wants to take out the battery 130 from the casing 110, the keypad 120 is slid away from the predetermined position relative to the casing 110 for opening the open end of the cavity 114, followed by taking out the battery 130 from the cavity 114, as shown sequentially in FIG. 3A, FIG. 2A and FIG. 1.

To slide the keypad 120 away from the predetermined position relative to the casing 110 by an exerted force, the latch male 182 of the second fixing unit 180 must be pressed down to horizontally disengage the latch male 182 from the latch female 184, followed by sliding the keypad 120 from the predetermined position relative to the casing 110 to vertically disengage the latch male 182 from the latch female 184, as shown in FIG. 2B.

To replace the battery 130 in the casing 110, the above-described two operations should be implemented.

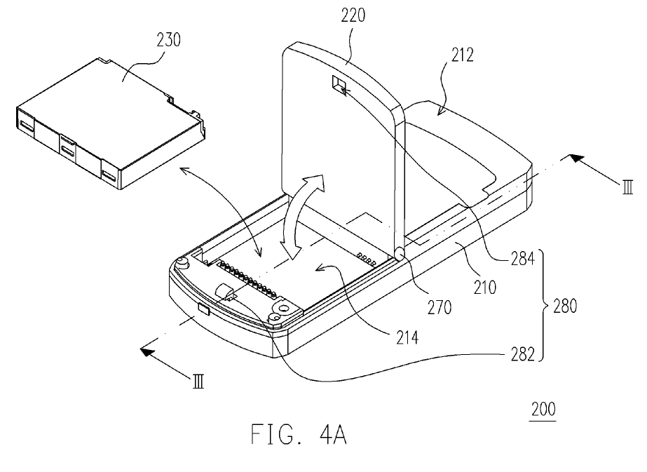

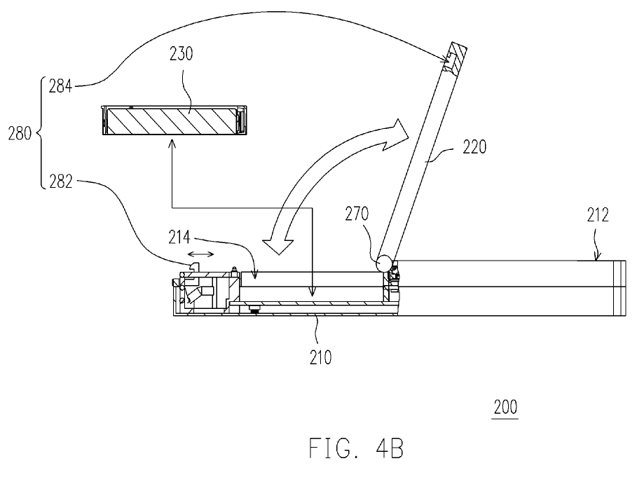

FIG. 4A is a perspective view of a mobile telecommunication device with a front embedded battery according to the second embodiment of the present invention, while FIG. 4B is a cross-sectional view along line III-III in FIG. 4A. Referring to FIGS. 4A and 4B, the second embodiment is similar to the first embodiment except for the relative moving manner between the casing and the keypad. A keypad 220 of the mobile telecommunication device 200 in the second embodiment is pivoted on the front surface 212 of the casing 210, so that the keypad 220 can swing relatively to the casing 210 for opening or closing an open end of the cavity 214.

The mobile telecommunication device 200 further includes a hinge mechanism 270 disposed between the casing 210 and the keypad 220, and the keypad 220 can be pivoted on the front surface 212 of the casing 210 by means of the hinge mechanism 270. The hinge mechanism 270 includes elements such as a bearing and a shaft (not shown in the figure), which are disposed on the casing 210 and the keypad 220 respectively for providing the keypad 220 with swinging movements relative to the casing 210. In the second embodiment, the hinge mechanism 270 is served as a first fixing unit of the mobile telecommunication device 200. Besides, the mobile telecommunication device 200 further includes a second fixing unit 280 disposed between the casing 210 and the keypad 220 for restricting the keypad 220 at a predetermined position relative to the casing 210 incorporated in the hinge mechanism 270. In this way, the battery 230 is able to be fixed inside the cavity 214. The second fixing unit 280 includes a latch male 282 and a latch female 284, which are disposed on the casing 210 and the keypad 220 respectively for restricting the horizontal position of the keypad 220 relative to the casing 210. Besides, the latch male 282 can be disposed with resiliency on the casing 210, so that the latch male 282 can move laterally with an exerted force and be sprung back once the exerted force is released. An engagement between the latch male 282 and the latch female 284 can be released by exerting a force to the latch male 282.

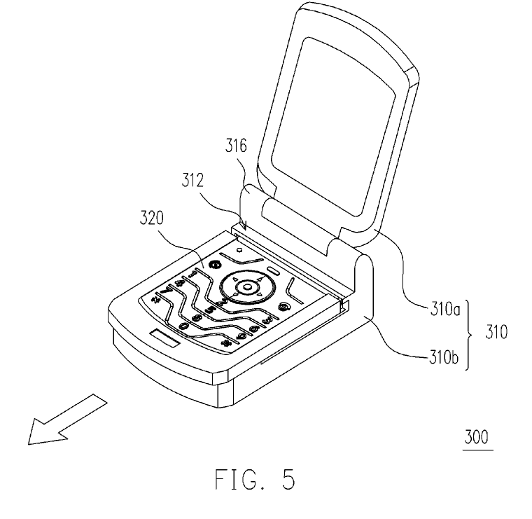

FIG. 5 is a perspective view of a mobile telecommunication device with a front embedded battery according to the third embodiment of the present invention. Referring to FIG. 5, the third embodiment is similar to the first embodiment except that whether the casing is an independent component or a multiple component. The casing 310 of the mobile telecommunication device 300 in the third embodiment includes a first sub-casing 310a and a second sub-casing 310b. The first sub-casing 310a is moveably connected with the second sub-casing 310b and the second sub-casing 310b has a cavity (not shown). In the third embodiment, the first sub-casing 310a is pivoted on the second sub-casing 310b by means of the hinge mechanism 316. In addition, the keypad 320 of the mobile telecommunication device 300 in the third embodiment is slid on the casing 310 for installing, taking out or replacing the battery (not shown). Besides, in another embodiment, the keypad 320 of the mobile telecommunication device 300 can be alternatively pivoted on the casing 310, which is not illustrated herein.

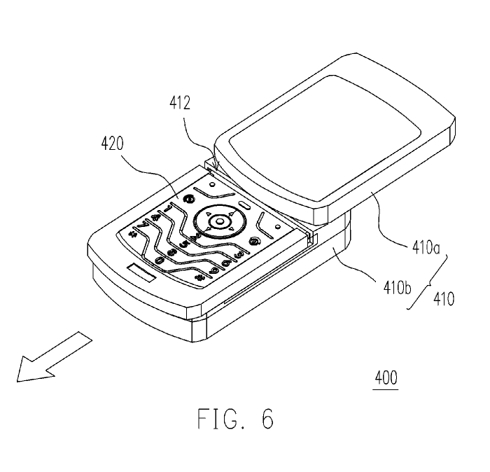

FIG. 6 is a perspective view of a mobile telecommunication device with a front embedded battery according to the fourth embodiment of the present invention. Referring to FIG. 6, the fourth embodiment is similar to the third embodiment except for the connecting manner between the two sub-casings. The casing 410 of the mobile telecommunication device 400 in the fourth embodiment includes a first sub-casing 410a and a second sub-casing 410b. The first sub-casing 410a is moveably connected with the second sub-casing 410b and the second sub-casing 410b has a cavity (not shown). In the fourth embodiment, the first sub-casing 410a is slid on the second sub-casing 410b by means of a sliding mechanism (not shown) for installing, taking out or replacing the battery (not shown). In addition, the keypad 420 of the mobile telecommunication device 400 in the fourth embodiment is slid on the casing 410; and in another embodiment, the keypad 420 of the mobile telecommunication device 400 can be alternatively pivoted on the casing 410, which is not illustrated herein.

In summary, in the present invention, a cavity is disposed under the keypad of the mobile telecommunication device and the keypad is able to move relatively to the casing for closing or opening an open end of the cavity so as to install, take out or replace the battery. Therefore, the present invention is able to effectively use a limited internal space of a mobile telecommunication device for getting a minimizing design. In addition, the present invention enables a user to replace a battery from the front side of the mobile telecommunication device, so that the convenience to replace a battery is further advanced.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A mobile telecommunication device with a front embedded battery, comprising:
a casing, having a front surface and a cavity, wherein an open end of the cavity is exposed over the front surface;
a keypad, moveably disposed on the front surface of the casing for opening or closing the open end of the cavity;
a first fixing unit, disposed between the casing and the keypad for fixing the position of the keypad relative to the casing;
a second fixing unit, disposed between the casing and the keypad for fixing the position of the keypad relative to the casing; and
a battery, stored inside the cavity.

2. The mobile telecommunication device with a front embedded battery as recited in claim 1, further comprising an image display panel disposed on the front surface of the casing and facing over the front surface.

3. The mobile telecommunication device with a front embedded battery as recited in claim 1, further comprising a sliding mechanism disposed between the casing and the keypad, wherein the keypad is able to slide relatively to the casing through the sliding mechanism.

4. The mobile telecommunication device with a front embedded battery as recited in claim 3, wherein the first fixing unit comprises a latch male and a corresponding latch female, the latch male is disposed on the sliding mechanism and the latch female is disposed on the keypad.

5. The mobile telecommunication device with a front embedded battery as recited in claim 1, wherein the first fixing unit is a hinge mechanism disposed between the casing and the keypad, while the keypad is able to swing relatively to the casing through the hinge mechanism.

6. The mobile telecommunication device with a front embedded battery as recited in claim 1, wherein the second fixing unit comprises a latch male and a corresponding latch female disposed on the casing and the keypad, respectively.

7. The mobile telecommunication device with a front embedded battery as recited in claim 1, further comprising a printed circuit board, wherein the printed circuit board is disposed inside the casing, and the cavity further has another open end facing inside the casing and closed by the printed circuit board.

8. The mobile telecommunication device with a front embedded battery as recited in claim 7, wherein the battery contacts the printed circuit board.

9. The mobile telecommunication device with a front embedded battery as recited in claim 1, wherein the casing comprises a first sub-casing and a second sub-casing, the first sub-casing is moveably connected with the second sub-casing, the second sub-casing has the cavity and the keypad is moveably disposed on the front surface of the second sub-casing for opening or closing the open end of the cavity.

10. The mobile telecommunication device with a front embedded battery as recited in claim 9, wherein the first sub-casing is pivoted on the second sub-casing.

11. The mobile telecommunication device with a front embedded battery as recited in claim 9, wherein the first sub-casing is slid on the second sub-casing.
